(19) United States
(12) Patent Application Publication
(10) Pub. No.: US 2011/0234798 A1
(43) Pub. Date: Sep. 29, 2011

(54) CAMERA DEVICE AND VEHICLE WITH SAME

(75) Inventor: YUAN-HSU CHOU, Tu-Cheng (TW)

(73) Assignee: HON HAI PRECISION INDUSTRY CO., LTD., Tu-Cheng (TW)

(21) Appl. No.: 12/857,576

(22) Filed: Aug. 17, 2010

(30) Foreign Application Priority Data
Mar. 26, 2010 (TW) 99108998

(51) Int. Cl. H04N 7/18; H04N 5/238

(52) U.S. Cl. 348/148; 348/369; 348/E07.085; 348/E05.04

(57) ABSTRACT

A camera device includes a camera module, a driving member, and a mirror. The camera module has an optical axis associated therewith. The driving member has a driving shaft. The mirror is coupled to the driving shaft. The driving member is configured for driving the mirror to rotate around the driving shaft. The mirror is obliquely oriented relative to the optical axis. The camera module is configured for capturing images formed in the mirror.

### BACKGROUND

1. Technical Field

The present disclosure relates to camera devices, and particularly, to a vehicle using the camera device.

2. Description of Related Art

With developments in automotive technology, performance, aerodynamics, and safety have been geared to meet desires of consumers. Rearview mirror systems equipped in vehicles are an important feature, allowing the driver to perceive the rear area of vehicle through the back window.

However, the rearview mirror systems may not always reduce the blind spots prevalent to the sides and rear corners of the vehicle, leaving much room for improvement.

Therefore, a camera device which can overcome the above-mentioned problems is desired.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the views.

FIG. 1 is an isometric view of a camera device according to a first embodiment.

FIG. 2 is an exploded, isometric view of the camera device of FIG. 1.

FIG. 3 is a schematic view of the camera device of FIG. 1, showing light path of the reflected rays of light.

FIG. 4 is a schematic view of the camera device of FIG. 1 with 60 degrees field of vision, showing light path of the reflected rays of light.

FIG. 5 is an isometric view of a vehicle with a camera device according an alternative embodiment.

FIG. 6A to FIG. 6C are schematic views of the camera device equipped in the vehicle of FIG. 5, showing light path of the reflected rays of light.

### DETAILED DESCRIPTION

Embodiments will now be described in detail below with reference to the drawings.

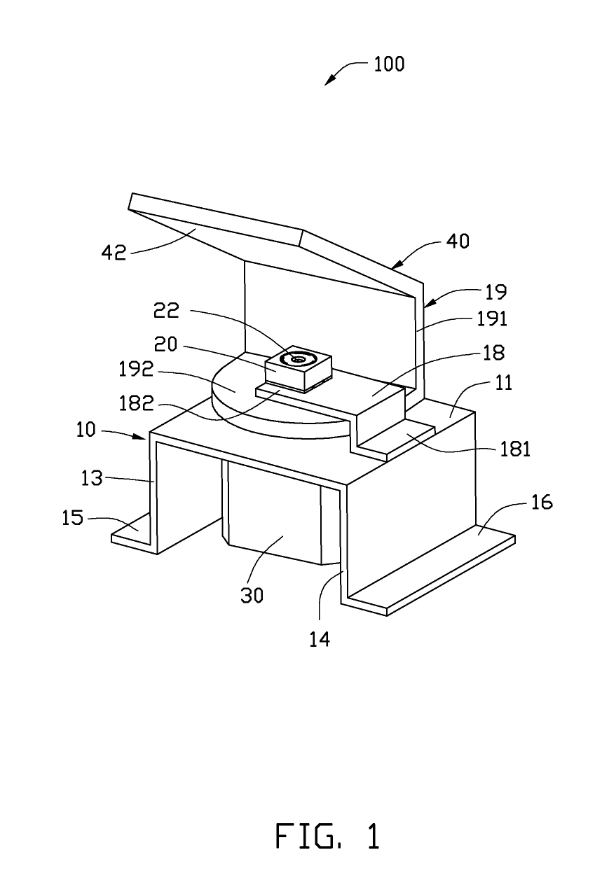

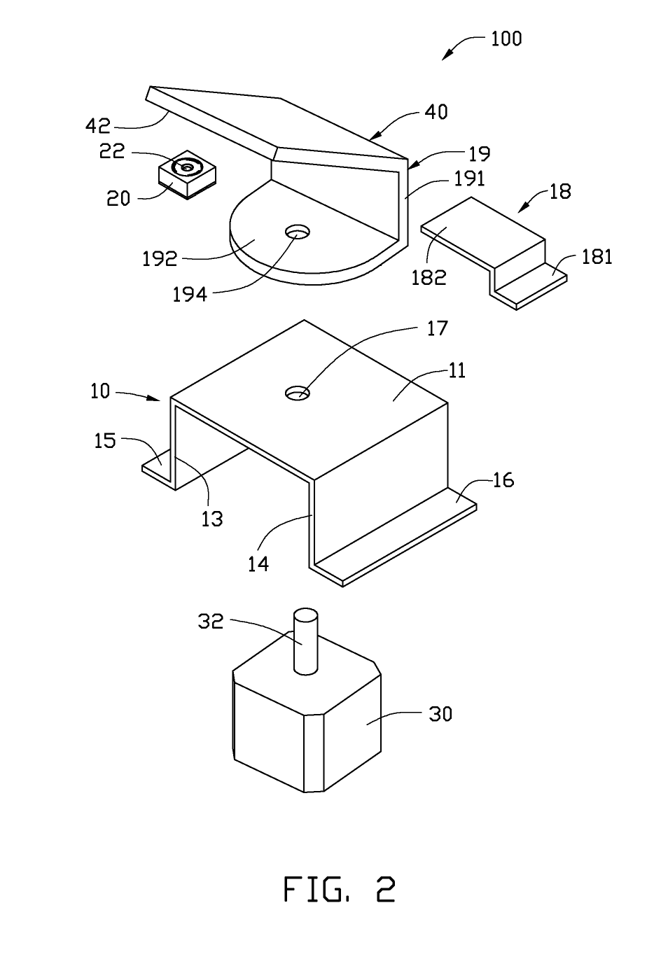

Referring to FIGS. 1 and 2, a camera device 100 in accordance with a first embodiment is provided. The camera device 100 includes a framework 10, a camera module 20, a driving member 30, and a mirror 40.

The framework 10 has a base 11, a first plate 13, and a second plate 14. The base 11 has two ends opposite to each other. The first plate 13 and the second plate 14 are connected with the two ends of the base 11 respectively. In this embodiment, the framework 10 is arch-shaped. The first plate 13 and the second plate 14 support the base 11 perpendicularly, and cooperatively forming a housing of the framework 10.

The framework 10 further includes a supporting arm 18 used to support the camera module 20. The supporting arm 18 has a first end 181 and a second end 182. The first end 181 of the supporting arm 18 is mounted on one side of the base 11, and the second end 182 extends from the first end 181 to the center of the base 11. In this embodiment, the second end 182 of the supporting arm 18 is parallel to the base 11, and there is a gap between the second end 182 of the supporting arm 18 and the base 11.

In this embodiment, The framework 10 includes a first plate 13 and a second plate 14. Extending out from the lower parts of the first and second plates, 13, 14 is a first mounting part 15 and a second mounting part 16. Therefore, the framework 10 can be mounted on a device (such as a vehicle) by the first mounting part 15 and the second mounting part 16.

The camera module 20 is attached to the supporting arm 18. The camera module 20 has an optical axis associated therewith and an aperture 22 extending from the top of the framework 10. The camera module 20 is positioned over the base 11 on the second end 182 of the supporting arm 18.

In this embodiment, the optical axis of the camera module 20 is perpendicular to the base 11.

The driving member 30 is positioned on an opposite side of the base 11 to the camera module 20, and received in the housing of the framework 10. The driving member 30 has a driving shaft 32. The base 11 further has a first shaft hole 17 defined in the center of the base 11. The driving shaft 32 extends through the first shaft hole 17.

It is to be understood that the driving member may be a motor.

The mirror 40 is positioned above the camera module 20. In this embodiment, the camera device 100 further includes a supporting bracket 19. The supporting bracket 19 has a supporting part 191, and a connecting part 192 which is perpendicular to the supporting part 191. The supporting part 191 is used to support the mirror 40. The connecting part 192 is located between the second end 182 of the supporting arm 18 and the base 11, and parallel to the base 11. In this embodiment, the connecting part 192 is semicircle shaped, and has a second shaft hole 194 defined in the center. The driving shaft 32 extending through the first shaft hole 17 is received in the second shaft hole 194, and is coupled to the connecting part 192, therefore, the mirror 40 is capable of rotating around the driving shaft 32 relative to the framework 10.

The mirror 40 has a reflective surface 42 facing the base 11. An angle between the reflective surface 42 and the optical axis of the camera module 20 is greater than 30 degrees and less than 50 degrees. The reflective surface 42 is obliquely oriented relative to the optical axis of the camera module 20. There is a space between the reflective surface 42 and the camera module 20, therefore the reflected light rays from objects (such as from other vehicles) reflecting off of the reflective surface 42 can enter the camera module 20 through the aperture 22.

The driving shaft 32 can be parallel or tilted to the optical axis of the camera module 20.

In this embodiment, the angle between the reflective surface 42 and the optical axis of the camera module 20 is 50 degrees. In order to adjust the angle between the reflective surface 42 and the optical axis of the camera module 20, the supporting part 191 and the mirror 40 are pivotably coupled to each other.

The mirror 40 can be a standard mirror, convex mirror or a concave mirror for example. In this embodiment, the mirror 40 is a standard mirror.

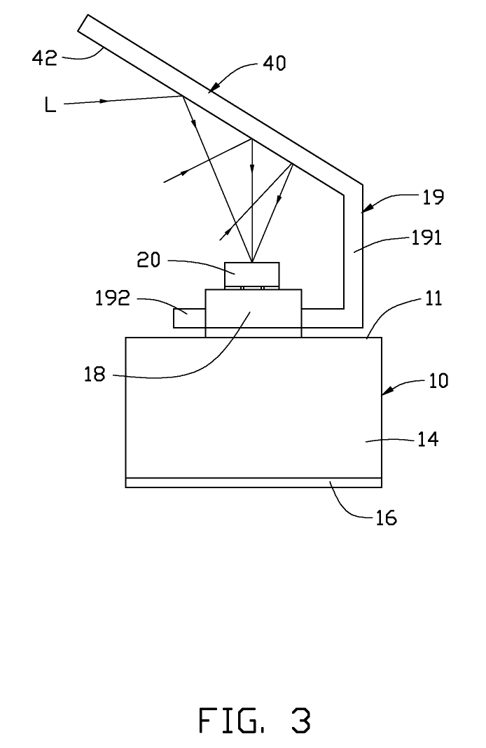

Referring to FIG. 3, it's a schematic view of the camera device 100, showing light path of the reflected rays of light. Reflected light L rays reflecting off of objects reflect off the reflective surface 42, and enter the camera module 20 through the aperture 22. Therefore, the camera module 20 is capable of capturing images.

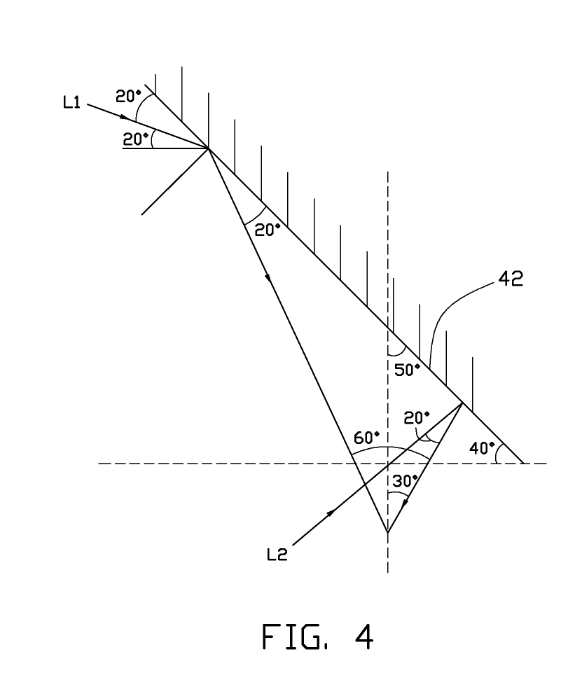

Referring to FIG. 4, it's a schematic view of the camera device 100 with 60 degrees field of view, showing light path of the reflected rays of light. In this embodiment, the optical axis of the camera module 20 is vertical, and the base 11 is horizontal. Reflected rays of light L1 is about 20 degrees above the horizon, and reflected rays of light L2 is about 40 degrees below the horizon. Both of the lights L1 and L2 reflect off the reflective surface 42, and enter the camera module 20 through the aperture 22. Therefore, the camera module 20 can capture images in the range according with the fields of vision of the camera module 20.

The camera module 20 can be equipped with different lenses with different fields of vision, therefore, the camera module 20 can capture images in different ranges.

With the driving member 30, the mirror 40 is capable of rotating around the driving shaft 32 relative to the framework 10. Therefore, reflected light rays from different areas and different directions can be reflected to the camera module 20 through the aperture 22. Accordingly, the camera module 20 can capture images from different areas and different directions.

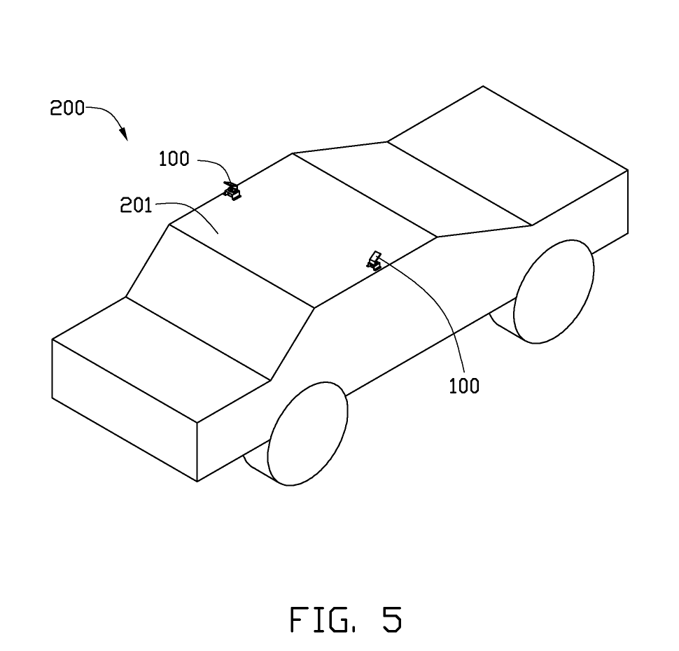

Referring to FIG. 5, a vehicle 200 in accordance with an alternative embodiment is provided. The vehicle 200 includes a compartment (not labeled in FIG. 5) having a roof 201 and two camera devices 100. The two camera devices 100 are arranged on the roof 201. In this embodiment, the two camera devices 100 are mounted on two opposite sides (i.e., the driver's side and the passenger's side) of the roof 201 respectively.

The mirror 40 of the camera device 100 mounted on the driver's side of the vehicle 200 can rotate and capture images in a range from the front of the vehicle 200 to the rear of the vehicle 200 panning the driver's side of the vehicle 200. That is, an overall panning viewing-angle of the camera device 100 of about 180 degrees.

The mirror 40 of the camera device 100 mounted on the passenger's side of the vehicle 200 can rotate and capture images in a range from the front of the vehicle 200 to the rear of the vehicle 200 panning the passenger's side of the vehicle 200. That is, an overall panning viewing-angle of the camera device 100 of about 180 degrees.

With dashboard displays electrically connected with the camera devices 100, the driver (not shown) in the vehicle 200 can see objects in different areas and different directions.

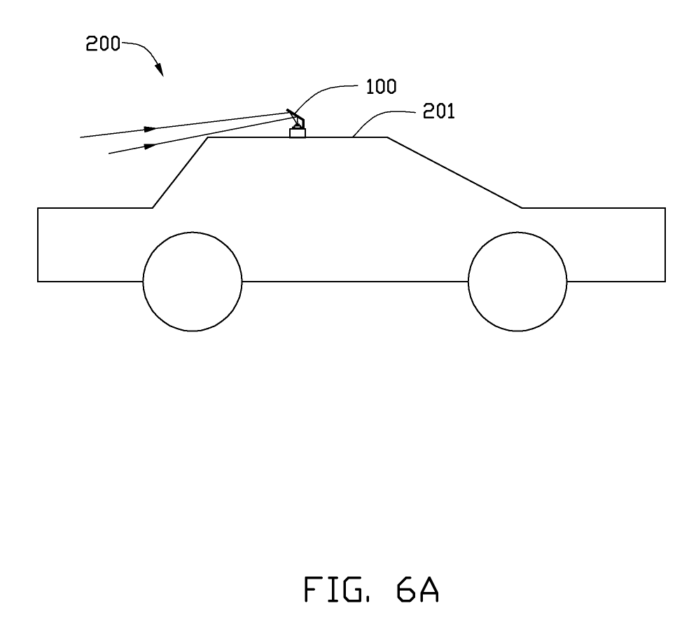

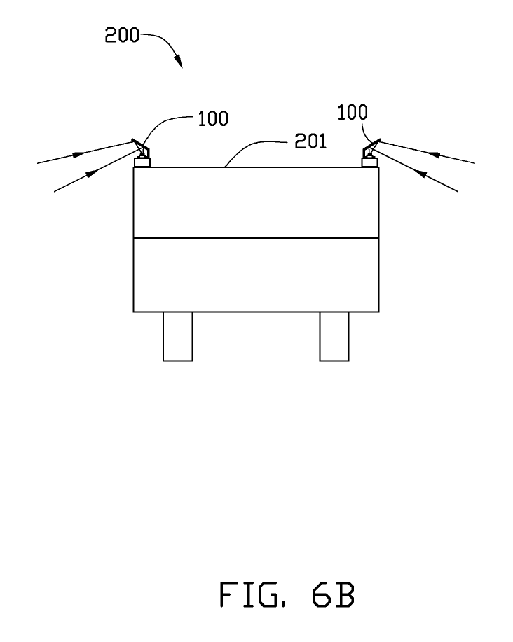

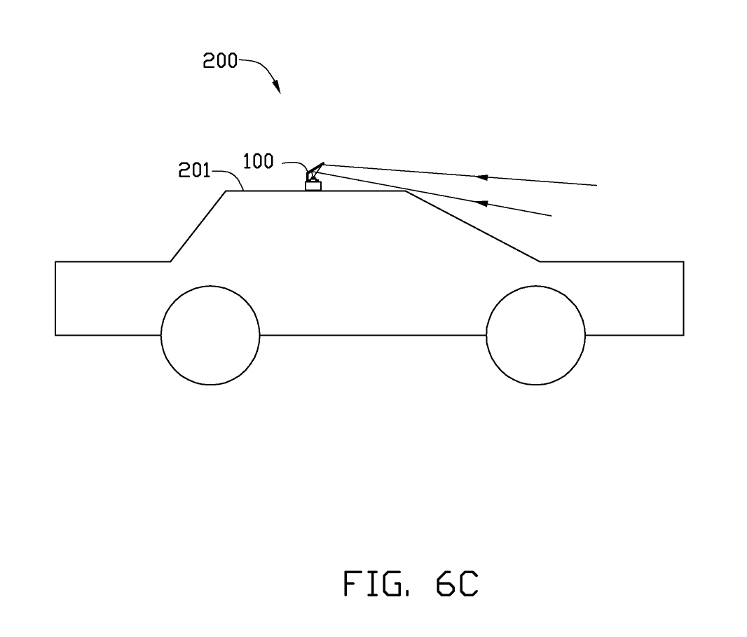

Referring to FIGS. 6A to 6C, these are schematic views of the camera devices equipped in the vehicle 200, showing light paths of the reflected rays of light.

Referring to 6A and FIG. 1, the mirror 40 (not labeled in FIG. 6A) of the camera device 100 faces the rear area of the vehicle 200, reflected light rays from the rear of the vehicle 200 are reflected to the camera module 20 (not labeled in FIG. 6A).

Referring to 6B and FIG. 1, the mirror 40 (not labeled in FIG. 6B) of the camera device 100 mounted on the driver's side of the vehicle 200 faces away from the driver's side area of the vehicle 200, reflected light rays from the driver's side area are reflected to the camera module 20 (not labeled in FIG. 6B). Therefore, the camera module 20 captures images from driver's side area of the vehicle 200 in the field of vision of the camera module 20.

The mirror 40 of the camera device 100 mounted on the passenger's side of the vehicle 200 faces away from the passenger's side area of the vehicle 200, reflected light rays from the passenger's side area are reflected to the camera module 20. Therefore, the camera module 20 captures images from passenger's side area of the vehicle 200 in the field of vision of the camera module 20.

Referring to 6C and FIG. 1, the mirror 40 (not labeled in FIG. 6C) of the camera device 100 faces towards the front area of the vehicle 200, reflected light rays from the front area are reflected to the camera module 20 (not labeled in FIG. 6C). Therefore, the camera module 20 captures images from front area of the vehicle 200 in the field of vision of the camera module 20.

It is to be understood that the two camera devices 100 also may be mounted on two opposite corners of the roof 201 respectively.

Due to the rotatable mirror 40 combined with the camera module 20, the camera device 100 can capture images from different areas and different directions. Thus, a camera device 100 can greatly reduce the blind spots prevalent to the sides and rear corners of the vehicle.

It is to be understood that the above-described embodiments are intended to illustrate rather than limit the disclosure. Variations may be made to the embodiments without departing from the spirit of the disclosure. The above-described embodiments illustrate the scope of the disclosure but do not restrict the scope of the disclosure.

What is claimed is:

1. A camera device, comprising:
a camera module having an optical axis associated therewith;
a driving member comprising a driving shaft; and
a mirror coupled to the driving shaft, the driving member being configured for driving the mirror to rotate around the driving shaft, the mirror being obliquely oriented relative to the optical axis, the camera module configured for capturing images formed in the mirror.

2. The camera device of claim 1, wherein the driving shaft coincides with or is parallel to the optical axis of the camera module.

3. The camera device of claim 1, further comprising a framework, wherein the framework includes a base and two plates supporting the base, and the camera module is positioned on the base.

4. The camera device of claim 3, further comprising a supporting arm mounted on the base, wherein the camera module is mounted on the supporting arm, and the optical axis of the camera module is perpendicular to the base.

5. The camera device of claim 3, further comprising a supporting bracket positioned on the base, wherein the mirror is pivotably coupled to the supporting bracket such that an angle between the mirror and the optical axis is adjustable.

6. The camera device of claim 5, wherein the supporting bracket includes a supporting part and a connecting part perpendicular to the supporting part, the supporting part supporting the mirror, the connecting part positioned between the supporting arm and the base, the connecting part being parallel to the base.

7. The camera device of claim 6, wherein the driving member is positioned on an opposite side of the base to the camera module, and the driving shaft extends through the base and is coupled to the connecting part of the connecting bracket.

8. The camera device of claim 5, wherein the angle between the mirror and the optical axis is in a range from 30 degrees to 50 degrees.

9. A camera device, comprising:
a camera module having an optical axis associated therewith and an aperture;
a driving member comprising a driving shaft;
a framework comprising a base therein; and
a mirror having a reflective surface, the mirror being coupled to the driving shaft, the reflective surface being obliquely oriented relative to the optical axis and facing the aperture, the camera module being positioned on the base for capturing images formed in the reflective surface.

10. The camera device of claim 9, further comprising two plates supporting the base and a supporting arm mounted on the base, wherein the camera module is mounted on the supporting arm, and the optical axis of the camera module is perpendicular to the base.

11. The camera device of claim 10, further comprising a supporting bracket positioned on the base, wherein the mirror is pivotably coupled to the supporting bracket such that an angle between the mirror and the optical axis is adjustable.

12. The camera device of claim 11, wherein the supporting bracket includes a supporting part and a connecting part perpendicular to the supporting part, the supporting part supporting the mirror, the connecting part positioned between the supporting arm and the base, the connecting part being parallel to the base.

13. The camera device of claim 12, wherein the driving member is positioned on an opposite side of the base to the camera module, and the driving shaft extends through the base and is coupled to the connecting part of the connecting bracket.

14. A vehicle, comprising:
a compartment having a roof; and
two camera devices, each of the camera device comprising:
a camera module having an optical axis associated therewith;
a driving member comprising a driving shaft; and
a mirror coupled to the driving shaft, the driving member being configured for driving the mirror to rotate around the driving shaft, the mirror being obliquely oriented relative to the optical axis, the camera module configured for capturing images formed in the mirror.

15. The vehicle of claim 14, wherein the two camera devices are mounted on two opposite sides of the roof respectively.

16. The vehicle of claim 14, further comprising a framework, wherein the framework includes a base and two plates supporting the base, and the camera module is positioned on the base.

17. The vehicle of claim 16, further comprising a supporting arm mounted on the base, wherein the camera module is mounted on the supporting arm, and the optical axis of the camera module is perpendicular to the base.

18. The vehicle of claim 16, further comprising a supporting bracket positioned on the base, wherein the mirror is pivotably coupled to the supporting bracket such that an angle between the mirror and the optical axis is adjustable.

19. The vehicle of claim 18, wherein the supporting bracket includes a supporting part and a connecting part perpendicular to the supporting part, the supporting part supporting the mirror, the connecting part positioned between the supporting arm and the base, and the connecting part being parallel to the base.

20. The vehicle of claim 19, wherein the driving member is positioned on an opposite side of the base to the camera module, and the driving shaft extends through the base and is coupled to the connecting part of the connecting bracket.
